(19) United States
(12) Patent Application Publication
(10) Pub. No.: US 2011/0002073 A1
(43) Pub. Date: Jan. 6, 2011

(54) OUTPUT BUFFER CIRCUIT AND OUTPUT BUFFER SYSTEM

(75) Inventors: Daisuke FUKUDA, Kyoto (JP); Tetsu Nagano, Osaka (JP); Takehiro Yano, Osaka (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/885,127

(22) Filed: Sep. 17, 2010

Related U.S. Application Data
(63) Continuation of application No. PCT/JP2009/001726, filed on Apr. 14, 2009.

(30) Foreign Application Priority Data
Sep. 2, 2008 (JP) 2008-224853

(51) Int. Cl. H02H 3/00

(52) U.S. Cl. 361/87

(57) ABSTRACT

An output buffer circuit of the present invention includes: a first output circuit having a first upper switching element and a first lower switching element, the first upper switching element having main terminals, one of the main terminals being maintained at a first voltage, the first lower switching element having main terminals, one of the main terminals being connected to the other main terminal of the upper switching element, the other main terminal of the first lower switching element being maintained at a second voltage, a portion where the other main terminal of the first upper switching element and one of the main terminals of the first lower switching element are connected to each other constituting an output portion for output to outside; a second output circuit having an output terminal connected to the output portion of the first output circuit; and a short-circuit detecting circuit configured to detect a short circuit of the output portion of the first output circuit. The output buffer circuit of the present invention is configured such that: when starting up the output buffer circuit, the second output circuit and the short-circuit detecting circuit are activated before activating the first output circuit; when the short circuit of the output portion is not detected, the first output circuit is activated; and when the short circuit of the output portion is detected, the first output circuit is not activated.

This is a continuation application under 35 U.S.C 111(a) of pending prior International application No. PCT/JP2009/001726, filed on Apr. 14, 2009. The disclosure of Japanese Patent Application No. 2008-224853 filed on Sep. 2, 2008 including specification, drawings and claims is incorporated here in by reference in its entirety.

### BACKGROUND OF THE INVENTION

1. Field of the Invention

The present invention relates to an output buffer circuit having a short-circuit detecting function and an output buffer system including a plurality of such output buffer circuits.

2. Description of the Related Art

In the case of realizing the integration of an output circuit configured to drive a load at a comparatively high current such as a power amplifier of an acoustic equipment, an audio output circuit of TV, a motor drive circuit, and the like, such IC is destroyed in some cases by a short circuit between a power supply terminal and an output terminal (such short circuit is hereinafter referred to as a “short to power”) or a short circuit between a GND terminal and the output terminal (such short circuit is hereinafter referred to as a “short to ground”), which is caused by, for example, a solder bridge at the time of IC implementation.

To solve this problem, an output control circuit having a short-circuit protection function is proposed (see Japanese Laid-Open Patent Application Publication No. 2005-252763, for example). FIG. 12 is a circuit diagram showing the configuration of the conventional output control circuit having the short-circuit protection function. In FIG. 12, an output control circuit 101 controls an output circuit 102. The output circuit 102 includes an upper switching element 104 and a lower switching element 105, which are connected to each other in series between a power supply VM and a GND. An upper predrive circuit 109 is connected to a gate of the upper switching element 104, and a lower predrive circuit 110 is connected to a gate of the lower switching element 105.

An upper shutoff circuit 113 configured to turn off the upper switching element 104 is connected to the gate of the upper switching element 104, and a short-to-ground detection comparator 117 is connected to the upper shutoff circuit 113. A voltage source configured to generate a reference voltage V1′ is connected to a plus input terminal of the short-to-ground detection comparator 117, and an output portion 106 constituted by a portion where the upper switching element 104 and the lower switching element 105 is connected each other is connected to a minus input terminal of the short-to-ground detection comparator 117. A power supply VC is connected through a switch SW1 to a power supply terminal of the short-to-ground detection comparator 117. With this configuration, the short-to-ground detection comparator 117 operates when the switch SW1 is turned on and electric power is supplied from the power supply VC. The short-to-ground detection comparator 117 outputs a signal to the upper shutoff circuit 113 to turn off the upper switching element 104 in a case where the voltage of the output portion 6 is lower than the reference voltage V1′.

A lower shutoff circuit 114 configured to turn off the lower switching element 105 is connected to the gate of the lower switching element 105, and a short-to-power detection comparator 118 is connected to the lower shutoff circuit 114. A voltage source configured to generate a reference voltage V2′ is connected to a minus input terminal of the short-to-power detection comparator 118, and the output portion 106 is connected to a plus input terminal of the short-to-power detection comparator 118. The power supply VC is connected through a switch SW2 to a power supply terminal of the short-to-power detection comparator 118. With this configuration, the short-to-power detection comparator 118 operates when the switch SW2 is turned on and the electric power is supplied from the power supply VC. The short-to-power detection comparator 118 outputs a signal to the lower shutoff circuit 114 to turn off the lower switching element 105 in a case where the voltage of the output portion 106 is higher than the reference voltage V2′.

Further, an upper ASO (area of safe operation) detecting circuit 115 configured to detect an ASO level of the upper switching element 104 is connected to the gate of the upper switching element 104, and a lower ASO detecting circuit 116 configured to detect the ASO level of the lower switching element 105 is connected to the gate of the lower switching element 105. In a case where the ASO level of the upper switching element 104 is a preset ASO level or higher, the upper ASO detecting circuit 115 turns on the switch SW1 so as to activate the short-to-ground detection comparator 117. In a case where the ASO level of the upper switching element 104 is the preset ASO level or lower, the upper ASO detecting circuit 115 turns off the switch SW1 so as to deactivate the short-to-ground detection comparator 117. Moreover, in a case where the ASO level of the lower switching element 105 is the preset ASO level or higher, the lower ASO detecting circuit 116 turns on the switch SW2 so as to activate the short-to-power detection comparator 118. In a case where the ASO level of the lower switching element 105 is the preset ASO level or lower, the lower ASO detecting circuit 116 turns off the switch SW2 so as to deactivate the short-to-power detection comparator 118.

The conventional output control circuit configured as above operates as below.

FIG. 13 is a circuit diagram showing a condition of the conventional output control circuit in a case where the output portion 106 has caused the short to ground (short circuit to the GND). As shown in FIG. 13, in this state, in a case where the upper switching element 104 is turned on and the lower switching element 105 is turned off, the voltage of the output portion 106 becomes the voltage (potential) of the GND. Therefore, an overcurrent (indicated by an arrow) flows through the on-state upper switching element 104. Meanwhile, since the ASO level of the upper switching element 104 becomes equal to or higher than the ASO level preset in the upper ASO detecting circuit 115, the upper ASO detecting circuit 115 turns on the switch SW1. With this, the short-to-ground detection comparator 117 compares the voltage of the output portion 106 and the reference voltage V1′. Since the reference voltage V1′ is set to be higher than the voltage (GND) of the output portion 106 which is assumed to cause the short to ground, the short-to-ground detection comparator 17 outputs a signal to the upper shutoff circuit 113 to turn off the upper switching element 104, and the upper shutoff circuit 113 turns off the on-state upper switching element 104. With this, the overcurrent flowing through the switching element 104 ceases, so that the upper switching element 104 is prevented from being destroyed.

FIG. 14 is a circuit diagram showing a condition of the conventional output control circuit in a case where the output portion 106 has caused the short to power (short circuit to the power supply VM). As shown in FIG. 14, in this state, in a case where the upper switching element 104 is turned off and the lower switching element 105 is turned on, the voltage of the output portion 106 becomes the voltage (VM) of the power supply VM. Therefore, the overcurrent (indicated by an arrow) flows through the on-state lower switching element 105. Meanwhile, since the ASO level of the lower switching element 105 becomes equal to or higher than the ASO level preset in the lower ASO detecting circuit 116, the lower ASO detecting circuit 116 turns on the switch SW2. With this, the short-to-power detection comparator 118 compares the voltage of the output portion 106 and the reference voltage V2′. Since the reference voltage V2′ is set to be lower than the voltage (VM) of the output portion 106 which is assumed to cause the short to power, the short-to-power detection comparator 118 outputs a signal to the lower shutoff circuit 114 to turn off the lower switching element 105, and the lower shutoff circuit 114 turns off the on-state lower switching element 105. With this, the overcurrent flowing through the lower switching element 105 ceases, so that the lower switching element 105 is prevented from being destroyed.

### SUMMARY OF THE INVENTION

However, in accordance with the configuration of the conventional output control circuit, there is concern that the flow of the overcurrent may destroy the switching elements 104 and 105.

To be specific, in a case where the upper switching element 104 is turned on and the lower switching element 105 is turned off with the output portion 106 short-circuited to ground, the overcurrent flows through the upper switching element 104 until the upper switching element 104 is turned off. For example, in a case where a response time of the upper ASO detecting circuit 115, the short-to-ground detection comparator 117, or the upper shutoff circuit 113 is long, and it takes time to turn off the upper switching element 104, or in a case where the voltage of the power supply VM is set to be high, and an electric power loss generated at the upper switching element 104 is too large, the upper switching element 104 is destroyed before it is turned off.

Moreover, in a case where the upper switching element 104 is turned off and the lower switching element 105 is turned on with the output portion 106 short-circuited to power, the overcurrent flows through the lower switching element 105 until the lower switching element 105 is turned off. For example, in a case where the response time of the lower ASO detecting circuit 116, the short-to-power detection comparator 118, or the lower shutoff circuit 114 is long, and it takes time to turn off the lower switching element 105, or in a case where the voltage of the power supply VM is set to be high, and the electric power loss generated at the lower switching element 105 is too large, the lower switching element 105 is destroyed before it is turned off.

The present invention was made to solve these problems, and an object of the present invention is to provide an output buffer circuit capable of surely prevent a switching element of an output circuit from being destroyed by a short circuit, and an output buffer system including a plurality of such output buffer circuits.

In order to solve the above problems, an output buffer circuit of the present invention includes: a first output circuit including a first high voltage side switching element and a first low voltage side switching element, the first high voltage side switching element having main terminals, one of the main terminals being maintained at a first voltage, the first low voltage side switching element having main terminals, one of the main terminals being connected to the other main terminal of the high voltage side switching element, the other main terminal of the first low voltage side switching element being maintained at a second voltage which is lower than the first voltage, a portion where the other main terminal of the first high voltage side switching element and said one of the main terminals of the first low voltage side switching element are connected to each other constituting an output portion for output to outside; a second output circuit having an output terminal connected to the output portion of the first output circuit; and a short-circuit detecting circuit configured to detect a short circuit between the output portion of the first output circuit and an electrical path which is maintained at the first voltage or between the output portion of the first output circuit and an electrical path which is maintained at the second voltage (such short circuit is hereinafter referred to as “the short circuit of the output portion”), wherein: when starting up the output buffer circuit, the second output circuit and the short-circuit detecting circuit are activated before activating the first output circuit; when the short circuit of the output portion is not detected, the first output circuit is activated; and when the short circuit of the output portion is detected, the first output circuit is not activated.

In accordance with this configuration, in a case where the short circuit of the output portion is occurring, a short-circuit current flows through the second output circuit, the output portion, and a short-circuit point. Therefore, the short-circuit current does not flow through the high voltage side switching element and low voltage side switching element of the first output circuit. Moreover, the short-circuit current is suppressed by a current ability of the second output circuit. Therefore, the output circuits (the first output circuit and the second output circuit) can be surely prevented from being destroyed by the short circuit.

The output buffer circuit may further include a control circuit configured to control operations of the first output circuit, the second output circuit, and the short-circuit detecting circuit, wherein the control circuit may be configured such that: when starting up the output buffer circuit, the control circuit activates the second output circuit and the short-circuit detecting circuit before activating the first output circuit; when the short circuit of the output portion is not detected, the control circuit activates the first output circuit; and when the short circuit of the output portion is detected, the control circuit does not activate the first output circuit.

It is preferable that a current drive ability of the second output circuit be lower than a current drive ability performed by the first high voltage side switching element of the first output circuit and the first low voltage side switching element of the first output circuit. In accordance with this configuration, the short-circuit current can be surely suppressed.

The second output circuit may include a high voltage side output circuit configured to discharge a current to the output terminal and a low voltage side output circuit configured to suction the current from the output terminal. In accordance with this configuration, the operation of the first output circuit and the operations of the high voltage side output circuit and low voltage side output circuit of the second output circuit after the detection of the short circuit can be combined freely depending on situations.

The output buffer circuit may be configured such that the high voltage side output circuit and the low voltage side output circuit are activated at the same time, and the short-circuit detecting circuit is activated. In accordance with this configuration, since the high voltage side output circuit and the low voltage side output circuit are activated at the same time, the short circuit can be detected comparatively quickly.

The output buffer circuit may be configured such that: one of the high voltage side output circuit and the low voltage side output circuit is activated, and the short-circuit detecting circuit is activated; and when the short circuit is not detected, the other one of the high voltage side output circuit and the low voltage side output circuit is activated, and the short-circuit detecting circuit is activated. In accordance with this configuration, the current of the second output circuit is suppressed as compared to a case where the high voltage side output circuit and the low voltage side output circuit are activated at the same time. Therefore, the short circuit can be detected with low power consumption.

The short-circuit detecting circuit may be configured to compare a voltage of the output portion of the first output circuit with a preset voltage to detect the short circuit.

The output buffer circuit may be configured such that when activating the first output circuit, the first high voltage side switching element of the first output circuit and the high voltage side output circuit of the second output circuit are turned on at the same time and the first low voltage side switching element of the first output circuit and the low voltage side output circuit of the second output circuit are turned off at the same time, or the first high voltage side switching element of the first output circuit and the high voltage side output circuit of the second output circuit are turned off at the same time and the first low voltage side switching element of the first output circuit and the low voltage side output circuit of the second output circuit are turned on at the same time.

In accordance with this configuration, the load connected to the output portion can be driven by the current ability which is higher by the second output circuit than a case where only the first output circuit is activated.

The second output circuit may include a second high voltage side switching element and a second low voltage side switching element, the second high voltage side switching element having main terminals, one of the main terminals being maintained at a third voltage, the second low voltage side switching element having main terminals, one of the main terminals being connected to the other main terminal of the second high voltage side switching element, the other one of the main terminals of the second low voltage side switching element being maintained at a fourth voltage which is lower than the third voltage, a portion where the other main terminal of the second high voltage side switching element and said one of the main terminals of the second low voltage side switching element are connected to each other constituting the output terminal of the second output circuit.

The second high voltage side switching element may constitute a high voltage side output circuit configured to discharge a current to the output terminal, and the second low voltage side switching element may constitute a low voltage side output circuit configured to suction the current from the output terminal.

The output buffer circuit may be configured such that when the short-circuit detecting circuit does not detect the short circuit of the output portion, the second output circuit stops operating.

Moreover, an output buffer system of the present invention includes a plurality of the output buffer circuits, wherein when the short circuit of the output portion of the first output circuit of any one of the output buffer circuits is detected, the first output circuits of all the output buffer circuits are not activated.

In accordance with this configuration, in a case where the short circuit is occurring at the first output circuit of any of the output buffer circuits, the entire system can be stopped quickly.

The present invention is configured as explained above and has an effect of being able to provide an output buffer circuit and an output buffer system, each of which is capable of surely preventing a switching element of an output circuit from being destroyed by a short circuit.

The above object, other objects, features and advantages of the present invention will be made clear by the following detailed explanation of preferred embodiments with reference to the attached drawings.

### BRIEF DESCRIPTION OF THE DRAWINGS

FIG. 1 is a circuit diagram showing the configuration of an output buffer circuit according to Embodiment 1 of the present invention.

FIG. 2 is a circuit diagram showing specific configuration examples of a second output circuit and a short-circuit detecting circuit of the output buffer circuit of FIG. 1.

FIG. 3 is a flow chart showing steps of operation control by a control circuit of the output buffer circuit of FIG. 1.

FIGS. 4(a) and 4(b) are timing charts showing changes of control signals and outputs over time when the output buffer circuit of FIG. 1 starts up. FIG. 4(a) is a diagram showing a case where the short circuit is not occurring, and FIG. 4(b) is a diagram showing a case where the short circuit (short to ground) is occurring.

FIG. 5 is a circuit diagram showing a condition of the output buffer circuit in a case where the short to ground of an output portion is occurring.

FIG. 6 is a circuit diagram showing a condition of the output buffer circuit in a case where the short to power of the output portion is occurring.

FIG. 7 is a circuit diagram showing the configuration of the output buffer circuit according to Embodiment 2 of the present invention.

FIG. 8 is a flow chart showing steps of the operation control by the control circuit of the output buffer circuit of FIG. 7.

FIG. 9 is a flow chart showing steps of the operation control by the control circuit of the output buffer circuit according to Embodiment 3 of the present invention.

FIG. 10 is a circuit diagram showing the configuration of a three-phase output buffer system according to Embodiment 4 of the present invention.

FIG. 11 is a flow chart showing steps of the operation control by the control circuit of the three-phase output buffer system according to Embodiment 4 of the present invention.

FIG. 12 is a circuit diagram showing the configuration of a conventional output control circuit having a short-circuit protection function.

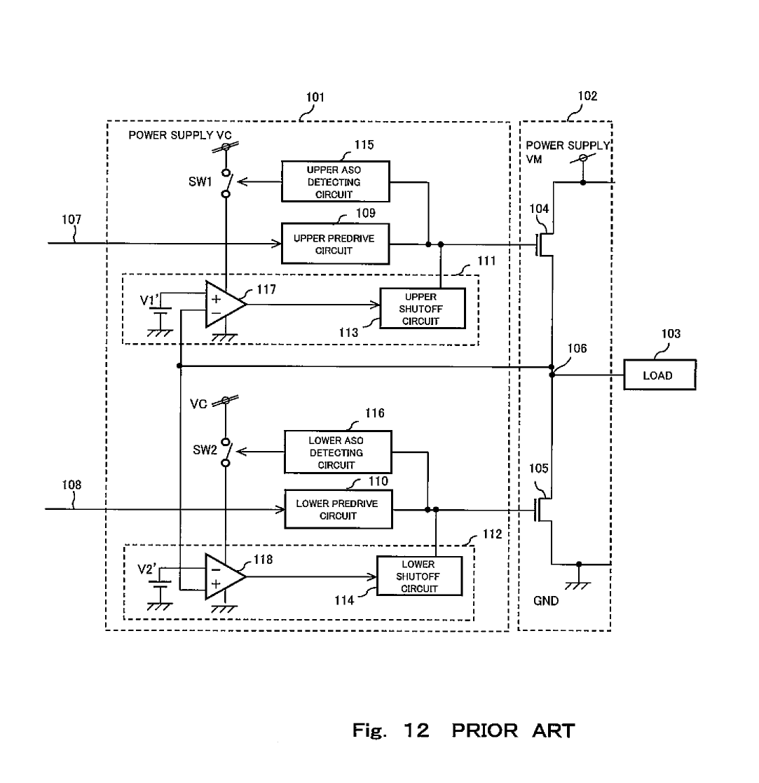

FIG. 13 is a circuit diagram showing a condition of the conventional output control circuit in a case where the output portion has caused the short to ground.

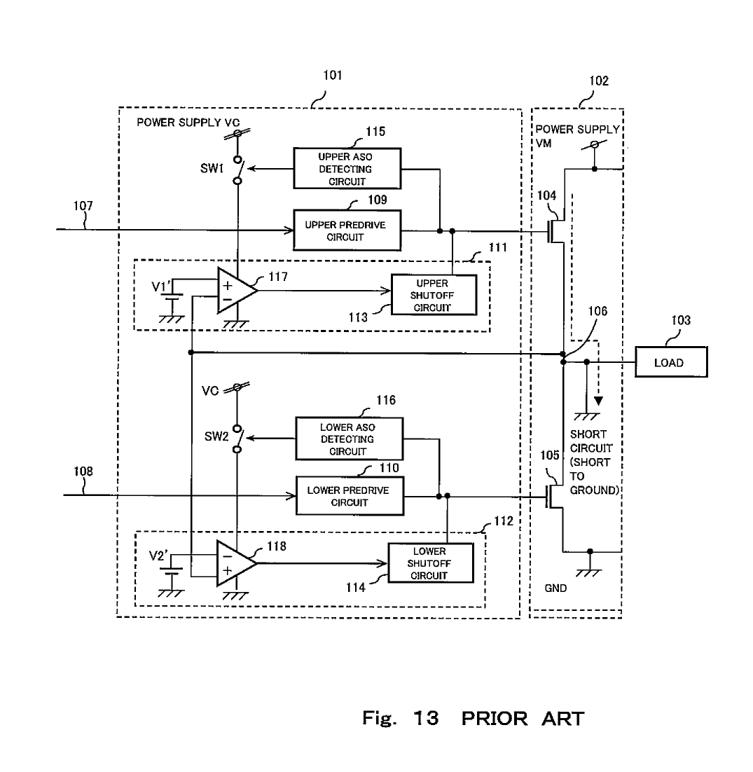

FIG. 14 is a circuit diagram showing a condition of the conventional output control circuit in a case where the output portion has caused the short to power.

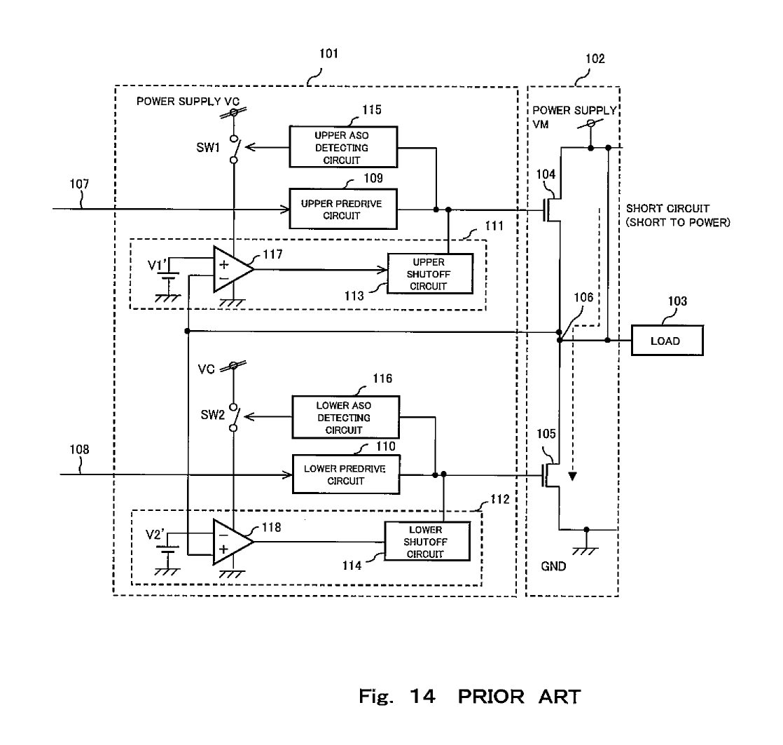

### DESCRIPTION OF THE PREFERRED EMBODIMENTS

Hereinafter, preferred embodiments of the present invention will be explained in reference to the drawings. In all of drawings, the same reference numbers are used for the same or corresponding components, and a repetition of the same explanation is avoided.

### Embodiment 1

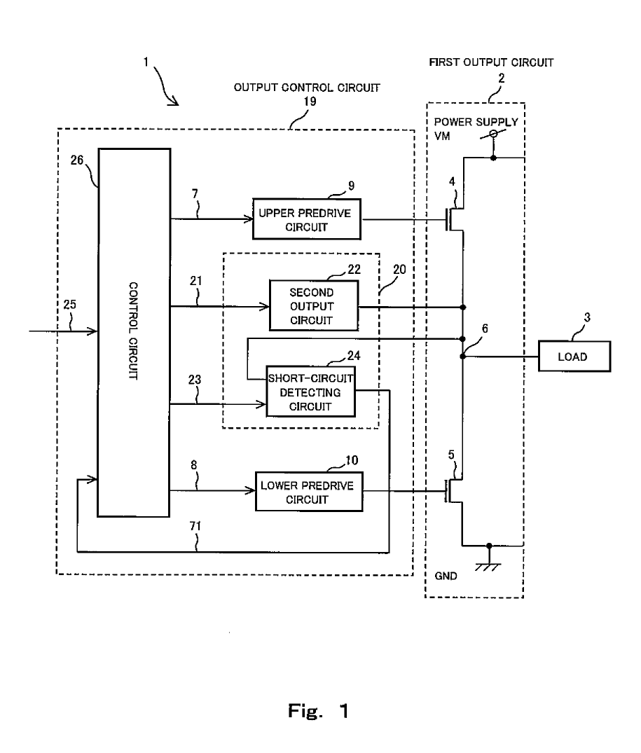

FIG. 1 is a circuit diagram showing the configuration of an output buffer circuit according to Embodiment 1 of the present invention.

As shown in FIG. 1, an output buffer circuit 1 includes a first output circuit 2 and an output control circuit 19 configured to control the first output circuit 2.

The first output circuit 2 includes an upper switching element (first high voltage side switching element) 4 and a lower switching element (first low voltage side switching element) 5, which are connected to each other in series between a power supply VM and a GND. Here, in the present invention, for convenience sake, terminals of each switching element are defined as below. A pair of terminals, through which a current flows in and flows out the switching element, are defined as main terminals, the current being allowed to flow through or being blocked by the switching element by turning on or off the switching element. Moreover, a terminal, to which a control signal for controlling ON and OFF of the switching element is input is defined as a control terminal. In accordance with these definitions, for example, in a field-effect transistor (FET), a source and a drain are the pair of main terminals, and a gate is the control terminal. In a bipolar transistor, an emitter and a collector are the pair of main terminals, and a base is the control terminal. Moreover, the power supply VM and the GND are one example of a voltage applying unit configured to apply a pair of voltages (potentials). The voltage applying unit may apply a pair of voltages having a voltage difference (potential difference) therebetween.

Specifically, one of the main terminals of the upper switching element 4 is connected to a power supply terminal (not shown), and the power supply terminal is connected to the power supply VM and is maintained at a voltage VM. One of the main terminals of the lower switching element 5 is connected to the other main terminal of the upper switching element 4 through a node 6. The other main terminal of the lower switching element 5 is connected to a ground terminal (not shown), and the ground terminal is connected to the GND and is maintained at a GND potential (voltage). The node 6 constitutes an output portion (electric output portion) of the first output circuit 2 for output to outside. The node 6 is hereinafter referred to as the output portion. A load 3 is connected to the output portion 6. The upper switching element 4 and the lower switching element 5 are operated by a below-described control circuit 26 in a complementary manner. To be specific, the upper switching element 4 is turned on, and at the same time, the lower switching element 5 is turned off. The upper switching element 4 is turned off, and at the same time, the lower switching element 5 is turned on. Herein, each of the upper switching element 4 and the lower switching element 5 is constituted by an N-channel MOSFET.

The output control circuit 19 includes an upper predrive circuit 9, a lower predrive circuit 10, a short-circuit protection circuit 20, and the control circuit 26.

The upper predrive circuit 9 is connected to the control terminal (gate) of the upper switching element 4. The control circuit 26 inputs an upper switching element control signal 7 to the upper predrive circuit 9. The upper predrive circuit 9 inputs a drive signal corresponding to the upper switching element control signal 7 to the control terminal of the upper switching element 4 to cause the upper switching element 4 to operate (drive) in accordance with the upper switching element control signal 7. The lower predrive circuit 10 is connected to the control terminal (gate) of the lower switching element 5. The control circuit 26 inputs a lower switching element control signal 8 to the lower predrive circuit 10. The lower predrive circuit 10 inputs a drive signal corresponding to the lower switching element control signal 8 to the control terminal of the lower switching element 5 to cause the lower switching element 5 to operate (drive) in accordance with the lower switching element control signal 8.

The short-circuit protection circuit 20 includes a second output circuit 22 and a short-circuit detecting circuit 24. The second output circuit 20 has an output terminal (electric output terminal) connected to the output portion (node) 6 of the first output circuit 2. The control circuit 26 inputs a second output circuit control signal 21 to the second output circuit 22. The second output circuit 22 outputs a predetermined voltage to the output portion 6 in accordance with the second output circuit control signal 21.

A short-circuit detecting circuit control signal 23 output from the control circuit 26 and the voltage of the output portion 6 are input to the short-circuit detecting circuit 24. The short-circuit detecting circuit 24 outputs a short-circuit detection signal 71 to the control circuit 26 based on the voltage of the output portion 6 at the time of the input of the short-circuit detecting circuit control signal (herein, a below-described H-level signal) 23. The short-circuit detection signal 71 indicates a detection result of the short circuit of the output portion 6.

The control circuit 26 controls the operations of the first output circuit 2 and the output control circuit 19. Command signals, such as a start-up/stop signal 25, and the short-circuit detection signal 71 are input to the control circuit 26. Based on the input command signals and short-circuit detection signal 71, the control circuit 26 outputs the upper switching element control signal 7, the lower switching element control signal 8, the second output circuit control signal 21, and the short-circuit detecting circuit control signal 23 respectively to the upper switching element 4, the lower switching element 5, the second output circuit 22, and the short-circuit detecting circuit 24 to control the operations of these elements and circuits. The control circuit 26 may have a signal processing function and is constituted by a logic circuit, a CPU, an analog circuit, or the like. In the present embodiment, the control circuit 26 is constituted by the logic circuit.

Next, specific configuration examples of the second output circuit 22 and the short-circuit detecting circuit 24 will be explained.

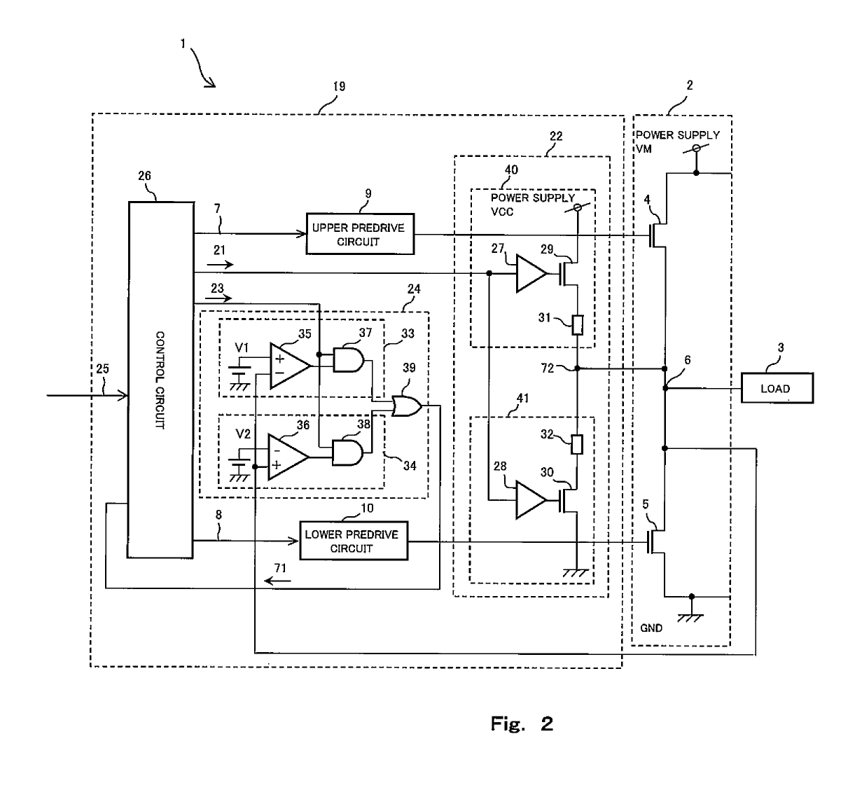

FIG. 2 is a circuit diagram showing the specific configuration examples of the second output circuit 22 and the short-circuit detecting circuit 24. As shown in FIG. 2, the second output circuit 22 includes an upper output circuit (high voltage side output circuit) 40 and a lower output circuit (low voltage side output circuit) 41. The upper output circuit 40 includes an upper switching element (second high voltage side switching element) 29, an upper resistor 31, and an upper drive circuit 27. The lower output circuit 41 includes a lower switching element (second low voltage side switching element) 30, a lower resistor 32, and a lower drive circuit 28. The upper switching element 29 and the lower switching element 30 are connected to each other in series between a power supply VCC and the GND. The power supply VCC and the GND are one example of the voltage applying unit configured to apply a pair of voltages. The voltage applying unit may apply a pair of voltages having a voltage difference therebetween. It is preferable that an output voltage of the second output circuit 22 be lower than the voltage VM in order to prevent the current from flowing backward to the power supply VM. Therefore, in order to surely prevent this, it is more preferable that a voltage VCC of the power supply VCC be equal to or lower than the voltage VM of the power supply VM (VCC≦VM). In the present embodiment, the voltage VCC of the power supply VCC is equal to the voltage VM of the power supply VM (VCC=VM).

Specifically, one of the main terminals of the upper switching element 29 is connected to the power supply terminal, and the power supply terminal is connected to the power supply VCC and is maintained at the voltage VCC. The upper resistor 31 is connected to the other main terminal of the upper switching element 29. The lower resistor 32 is connected through a node 72 to the upper resistor 31. One of the main terminals of the lower switching element 30 is connected to the lower resistor 32. The other main terminal of the lower switching element 30 is connected to the ground terminal, and the ground terminal is connected to the GND and is maintained at the GND potential. The node 72 constitutes the output terminal (electric output terminal) of the second output circuit 2 for output to outside. The node 72 is hereinafter referred to as the output terminal. The output terminal 72 is connected to the output portion 6 of the first output circuit 2. Herein, each of the upper switching element 29 and the lower switching element 30 is constituted by an N-channel MOSFET.

The upper drive circuit 27 is connected to the control terminal (gate) of the upper switching element 29. The control circuit 26 inputs the second output circuit control signal 21 to the upper drive circuit 27. The upper drive circuit 27 inputs a drive signal corresponding to the second output circuit control signal 21 to the control terminal of the upper switching element 29 to cause the upper switching element 29 to operate (drive) in accordance with the second output circuit control signal 21. The lower drive circuit 28 is connected to the control terminal (gate) of the lower switching element 30. The control circuit 26 inputs the second output circuit control signal 21 to the lower drive circuit 28. The lower drive circuit 28 inputs a drive signal corresponding to the second output circuit control signal 21 to the control terminal of the lower switching element 30 to cause the lower switching element 30 to operate (drive) in accordance with the second output circuit control signal 21. In the present embodiment, the upper switching element 29 and the lower switching element 30 are turned on or off at the same time by the control circuit 26.

Moreover, a current drive ability of the second output circuit 22 is set to be lower than a current drive ability performed by the upper switching element 4 of the first output circuit 2 and the lower switching element 5 of the first output circuit 2. The current drive ability denotes a current supply ability. In the present embodiment, the current drive ability is set to include a current discharging ability and a current suctioning ability. Here, the current discharging ability denotes an ability of supplying a positive-direction current, and the current suctioning ability is an ability of supplying a negative-direction (direction opposite the positive direction) current. The current discharging ability and current suctioning ability of the second output circuit 22 are respectively set to be lower than the current discharging ability of the upper switching element 4 of the first output circuit 2 and the current suctioning ability of the lower switching element 5 of the first output circuit 2. In the present embodiment, the current discharging ability of the second output circuit 22 is substantially a current value obtained by dividing a voltage difference of the voltage (herein, VCC) at which one of the main terminals of the upper switching element 29 of the second output circuit 22 is maintained with respect to the voltage (herein, GND) at which the other main terminal of the lower switching element 5 of the first output circuit 2 is maintained, by a total value of an ON resistance of the upper switching element 29 and a resistance value of the upper resistor 31. Moreover, the current suctioning ability of the second output circuit 22 is substantially a current value obtained by dividing a voltage difference of the voltage (herein, GND) at which the other main terminal of the lower switching element 30 of the second output circuit 22 is maintained with respect to the voltage (herein, VM) at which one of the main terminals of the upper switching element 4 of the first output circuit 2 is maintained, by a total value of an ON resistance of the lower switching element 30 and a resistance value of the lower resistor 32. Therefore, the ON resistance of the upper switching element 29 may be set to be high, and the upper resistor 31 may be omitted. Moreover, the ON resistance of the lower switching element 30 may be set to be high, and the lower resistor 32 may be omitted.

Meanwhile, the current discharging ability of the first output circuit 2 is substantially a current value obtained by dividing a voltage difference of the voltage (herein, VM) at which one of the main terminals of the upper switching element 4 of the first output circuit 2 is maintained with respect to the voltage (herein, GND) at which the other main terminal of the lower switching element 5 of the first output circuit 2 is maintained, by an ON resistance of the upper switching element 4. Moreover, the current suctioning ability of the first output circuit 2 is substantially a current value obtained by dividing a voltage difference of the voltage (herein, GND) at which the other main terminal of the lower switching element 5 of the first output circuit 2 is maintained with respect to the voltage (herein, VM) at which one of the main terminals of the upper switching element 4 of the first output circuit 2 is maintained, by an ON resistance of the lower switching element 5.

In the present embodiment, as long as the short to ground and the short to power can be detected, the current discharging ability and current suctioning ability of the second output circuit 22 are set to be as low as possible. Therefore, the current discharging ability and current suctioning ability of the second output circuit 22 are set to be adequately lower than the current discharging ability of the upper switching element 4 of the first output circuit 2 and the current suctioning ability of the lower switching element 5 of the first output circuit 2, respectively.

The short-circuit detecting circuit 24 includes a short-to-ground detecting circuit 33, a short-to-power detecting circuit 34, and a two-input short-circuit detecting OR circuit 39.

In the present embodiment, the short to power of the output portion 6 denotes the short circuit between the output portion 6 and a power supply terminal, not shown. In other words, the short to power of the output portion 6 denotes the short circuit between the output portion 6 and an electrical path (an electric wire, a circuit element, or the like) which is maintained at the voltage VM of the power supply VM in the first output circuit. Moreover, the short to ground of the output portion 6 denotes the short circuit between the output portion 6 and a ground terminal, not shown. In other words, the short to ground of the output portion 6 denotes the short circuit between the output portion 6 and an electrical path (an electric wire, a circuit element, or the like) which is maintained at the GND potential in the first output circuit.

The short-to-ground detecting circuit 33 includes a two-input short-to-ground detection comparator 35 and a two-input short-to-ground detecting AND circuit 37. A voltage source configured to output a reference voltage V1 is connected to a plus input terminal of the short-to-ground detection comparator 35, and the output portion 6 is connected to a minus input terminal thereof. An output terminal of the short-to-ground detection comparator 35 is connected to one of input terminals of the short-to-ground detecting AND circuit 37. The control circuit 26 inputs the short-circuit detecting circuit control signal 23 to the other input terminal of the short-to-ground detecting AND circuit 37. An output terminal of the short-to-ground detecting AND circuit 37 is connected to one of input terminals of the short-circuit detecting OR circuit 39. In a case where a voltage VOUT of the output portion 6 when the short to ground or the short to power is not occurring is a voltage value VZ, the voltage value VZ is substantially equal to the output voltage of the second output circuit 22 at this moment. The reference voltage V1 is a voltage as a criteria for determining whether or not the short to ground is occurring. In the present embodiment, the reference voltage V1 is set to be lower than the voltage VOUT (=VZ) of the output portion 6 when the short to ground or the short to power is not occurring (V1<VZ) and be higher than the voltage VOUT (=GND) of the output portion 6 when the short to ground is occurring (V1>GND). Therefore, the short-to-ground detection comparator 35 outputs L when the short to ground of the output portion 6 is not occurring and outputs H when the short to ground of the output portion 6 is occurring. Here, L and H respectively denote a “low level” and a “high level” in a binary signal. Moreover, when the short circuit is detected, the short-circuit detecting circuit control signal 23 output from the control circuit 26 becomes H. Therefore, the short-to-ground detecting AND circuit 37 outputs L when the short to ground of the output portion 6 is not occurring and outputs H when the short to ground of the output portion 6 is occurring.

The short-to-power detecting circuit 34 includes a two-input short-to-power detection comparator 36 and a two-input short-to-power detecting AND circuit 38. A voltage source configured to output a reference voltage V2 is connected to a minus input terminal of the short-to-power detection comparator 36, and the output portion 6 is connected to a plus input terminal thereof. An output terminal of the short-to-power detection comparator 36 is connected to one of input terminals of the short-to-power detecting AND circuit 38. The short-circuit detecting circuit control signal 23 is input to the other input terminal of the short-to-power detecting AND circuit 38. An output terminal of the short-to-power detecting AND circuit 38 is connected to the other input terminal of the short-circuit detecting OR circuit 39. The reference voltage V2 is a voltage as a criteria for determining whether or not the short to power is occurring. In the present embodiment, the reference voltage V2 is set to be higher than the voltage VOUT (=VZ) of the output portion 6 when the short to ground or the short to power is not occurring (V2>VZ) and lower than the voltage VOUT (=VM) of the output portion 6 when the short to power is occurring (V2<VM). Therefore, the short-to-power detection comparator 36 outputs L when the short to power of the output portion 6 is not occurring and outputs H when the short to power of the output portion 6 is occurring. Moreover, when the short circuit is detected, the short-circuit detecting circuit control signal 23 output from the control circuit 26 becomes H. Therefore, the short-to-power detecting AND circuit 38 outputs L when the short to power of the output portion 6 is not occurring and outputs H when the short to power of the output portion 6 is occurring.

Here, the reference voltages V1 and V2 needs to be set in consideration of the following. To be specific, the short circuit of the output portion 6 may occur through a resistor. In this case, the voltage of the output portion 6 becomes an intermediate value between VM and VZ or between GND and VZ. Therefore, in order to surely detect the short circuit in this case, it is desirable that each of the reference voltages V1 and V2 be set to be as close to VZ as possible. However, if each of the reference voltages V1 and V2 is too close to VZ, the possibility of occurrence of malfunctions (non-detections of the short circuit) increases. Therefore, each of the reference voltages V1 and V2 needs to be set in consideration of every changing factor to a level that the malfunctions do not occur.

As described above, the output terminal of the short-to-ground detecting AND circuit 37 is connected to one of the input terminals of the short-circuit detecting OR circuit 39, and the output terminal of the short-to-power detecting AND circuit 38 is connected to the other input terminal of the short-circuit detecting OR circuit 39. The output 71 of the short-circuit detecting OR circuit 39 is input to the control circuit 26. With this configuration, when the short to ground or the short to power of the output portion 6 is not occurring (when the short circuit is not occurring), each of the short-to-ground detecting AND circuit 37 and the short-to-power detecting AND circuit 38 outputs L to the short-circuit detecting OR circuit 39. Therefore, the short-circuit detecting OR circuit 39 outputs L to the control circuit 26. In contrast, when the short to ground or the short to power of the output portion 6 is occurring (when the short circuit is occurring), the short-to-ground detecting AND circuit 37 or the short-to-power detecting AND circuit 38 outputs H to the short-circuit detecting OR circuit 39. Therefore, the short-circuit detecting OR circuit 39 outputs H to the control circuit 26.

When the output 71 of the short-circuit detecting OR circuit 39 is H, the control circuit 26 determines that the short circuit is occurring. When the output 71 of the short-circuit detecting OR circuit 39 is L, the control circuit 26 determines that the short circuit is not occurring.

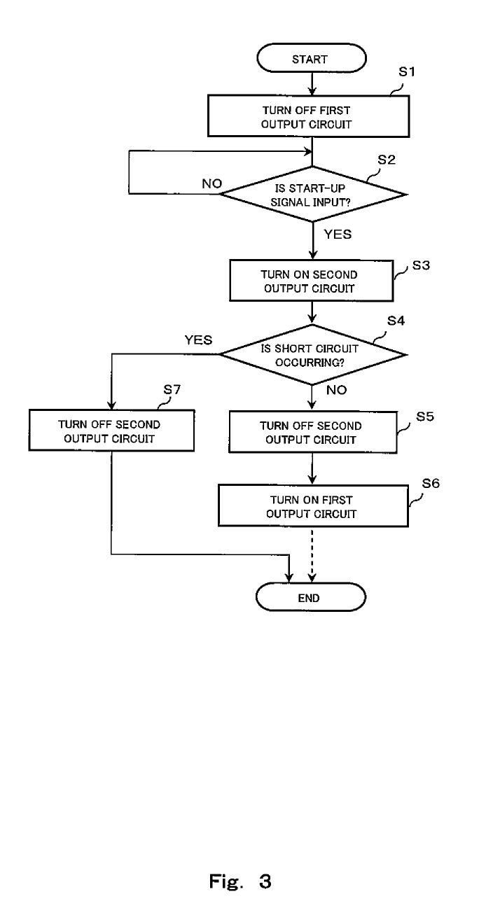

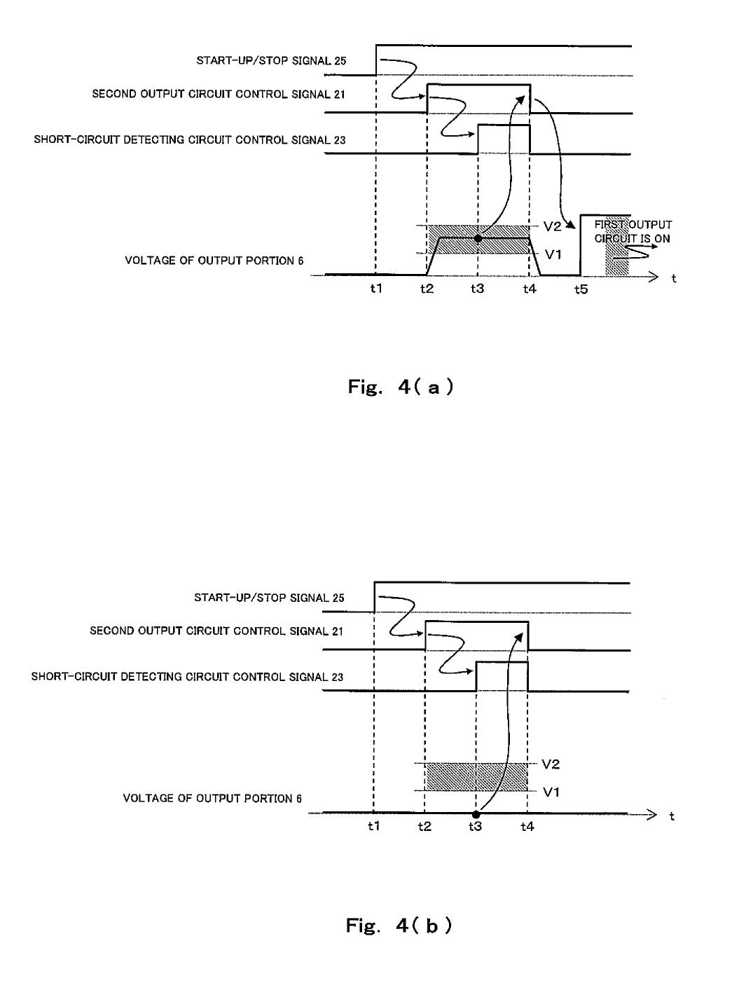

Next, the operations of the output buffer circuit 1 configured as above will be explained in reference to FIGS. 3 and 4.

FIG. 3 is a flow chart showing steps of operation control of the output buffer circuit 1 by the control circuit 26. FIGS. 4(a) and 4(b) are timing charts showing changes of control signals over time and outputs when the output buffer circuit 1 starts up. FIG. 4(a) is a diagram showing a case where the short circuit is not occurring, and FIG. 4(b) is a diagram showing a case where the short circuit (short to ground) is occurring. In the present embodiment, the control circuit 26 is constituted by a logic circuit and performs processing in accordance with an internal clock signal. As shown in FIG. 4, each step in the flow chart of FIG. 3 is carried out at a time interval of one clock or more.

As shown in FIG. 3, when the output buffer circuit 1 starts up, the control circuit 26 turns off (stops) the first output circuit 2 as a reset operation (Step S1). Here, turning off the first output circuit 2 denotes turning off both the switching element 4 and the switching element 5. Specifically, the control circuit 26 causes the upper switching element control signal 7 and the lower switching element control signal 8 to be L. With this, both the upper switching element 4 and the lower switching element 5 are turned off. Therefore, in this state, as shown in FIGS. 4(a) and 4(b), the voltage is not generated at the output portion 6.

Next, the control circuit 26 stands by for the input of a start-up signal (Step S2).

When the start-up signal is input to the control circuit 26 (YES in Step S2), the control circuit 26 turns on (activates) the second output circuit 22 (Step S3). Specifically, as shown in FIGS. 4(a) and 4(b), for example, when the start-up signal is input to the control circuit 26 as the start-up/stop signal 25 at a time t1 (when the start-up/stop signal 25 becomes H), the control circuit 26 causes the second output circuit control signal 21 to be H at a time t2. With this, both the upper switching element 29 and the lower switching element 30 of the second output circuit 22 are turned on.

Hereinafter, a case where the short circuit of the output portion 6 is not occurring and a case where the short circuit of the output portion 6 is occurring will be explained separately.

In a case where the short circuit (the short to ground or the short to power) of the output portion 6 is not occurring, as shown in FIG. 4(a), when the second output circuit 22 is turned on, the voltage VOUT of the output portion 6 becomes a predetermined voltage value VZ a little later than the turning-on of the second output circuit 22 (since, for example, a parasitic capacitance is charged). The predetermined voltage value VZ is a voltage value obtained by dividing a potential difference VCC between the power supply VCC and the GND into a combined resistance of the ON resistance of the upper switching element 29 and the resistance value of the upper resistor 31 and a combined resistance of the ON resistance of the lower switching element 30 and the resistance value of the lower resistor 32.

After the second output circuit 22 is turned on, the control circuit 26 determines whether or not the short circuit is occurring (Step S4). Specifically, for example, the control circuit 26 causes the short-circuit detecting circuit control signal 23 to be H at a time t3 that is a time after a certain time has elapsed since the second output circuit 22 is turned on. With this, inhibit circuits respectively constituted by the short-to-ground detecting AND circuit 37 and the short-to-power detecting AND circuit 38 are canceled. Thus, the short to ground and the short to power can be detected. Meanwhile, at this moment, the voltage VOUT of the output portion 6 is VZ, is higher than the reference voltage V1 of the short-to-ground detecting circuit 33, and is lower than the reference voltage V2 of the short-to-power detecting circuit 34. Therefore, the output 71 of the short-circuit detecting OR circuit 39 becomes L (remains at L). Then, the control circuit 26 determines that the short circuit of the output portion 6 is not occurring (NO in Step S4).

Then, the control circuit 26 turns off the second output circuit 22 (Step S5). Specifically, as shown in FIG. 4(a), for example, the control circuit 26 causes the second output circuit control signal 21 to be L at a time t4. With this, both the upper switching element 29 and the lower switching element 30 of the second output circuit 22 are turned off.

Then, the control circuit 26 turns on the first output circuit 2 (Step S6). Specifically, the control circuit 26 outputs the upper switching element control signal 7 and the lower switching element control signal 8 (at a time t5) in accordance with an output command signal which is input to the control circuit 26. For example, in a case where the output command signal is a signal indicating that H needs to be output, the control circuit 26 causes the upper switching element control signal 7 to be H and causes the lower switching element control signal 8 to be L. With this, the upper switching element 4 is turned on, and the lower switching element 5 is turned off. Thus, the output portion 6 outputs the signal of H (voltage value VM) to the load 3. In contrast, in a case where the output command signal is a signal indicating that L needs to be output, the control circuit 26 causes the upper switching element control signal 7 to be L and causes the lower switching element control signal 8 to be H. With this, the upper switching element 4 is turned off, and the lower switching element 5 is turned on. Thus, the output portion 6 outputs the signal of L (voltage value GND) to the load 3. FIG. 4(a) shows the voltage of the output portion 6 in a case where the output command signal indicating that H needs to be output is input to the control circuit 26.

Then, when a stop signal is finally input to the control circuit 26 as the start-up/stop signal 25, the control circuit 26 turns off the first output circuit 2 to terminate the control of the output buffer circuit 1.

Next, the case where the short circuit (the short to ground or the short to power) of the output portion 6 is occurring will be explained.

In a case where the short to ground of the output portion 6 is occurring, as shown in FIG. 4(b), when the second output circuit 22 is turned on, the voltage VOUT of the output portion 6 becomes the GND. As described above, after the control circuit 26 turns on the second output circuit 22, the control circuit 26 causes the short-circuit detecting circuit control signal 23 to be H in order to determine whether or not the short circuit is occurring (Step S4). With this, the short to ground and the short to power can be detected as described above. Meanwhile, since the voltage VOUT of the output portion 6 is the GND and is lower than the reference voltage V1 of the short-to-ground detecting circuit 33, the short-to-ground detection comparator 35 outputs H. Then, the short-to-ground detecting AND circuit 37 outputs H. With this, the output 71 of the short-circuit detecting OR circuit 39 becomes H. Then, the control circuit 26 determines that the short circuit of the output portion 6 is occurring (YES in Step S4).

Then, the control circuit 26 turns off the second output circuit 22 (Step S7) to terminate the control of the output buffer circuit 1.

Meanwhile, in a case where the short to power of the output portion 6 is occurring, when the second output circuit 22 is turned on, the voltage VOUT of the output portion 6 becomes VM. As described above, after the control circuit 26 turns on the second output circuit 22, the control circuit 26 causes the short-circuit detecting circuit control signal 23 to be H in order to determine whether or not the short circuit is occurring (Step S4). With this, the short to ground and the short to power can be detected as described above. Meanwhile, since the voltage VOUT of the output portion 6 is VM and is higher than the reference voltage V2 of the short-to-power detecting circuit 34, the short-to-power detection comparator 36 outputs H. Then, the short-to-power detecting AND circuit 38 outputs H. With this, the output 71 of the short-circuit detecting OR circuit 39 becomes H. Then, the control circuit 26 determines that the short circuit of the output portion 6 is occurring (YES in Step S4).

Then, the control circuit 26 turns off the second output circuit 22 (Step S7) to terminate the control of the output buffer circuit 1.

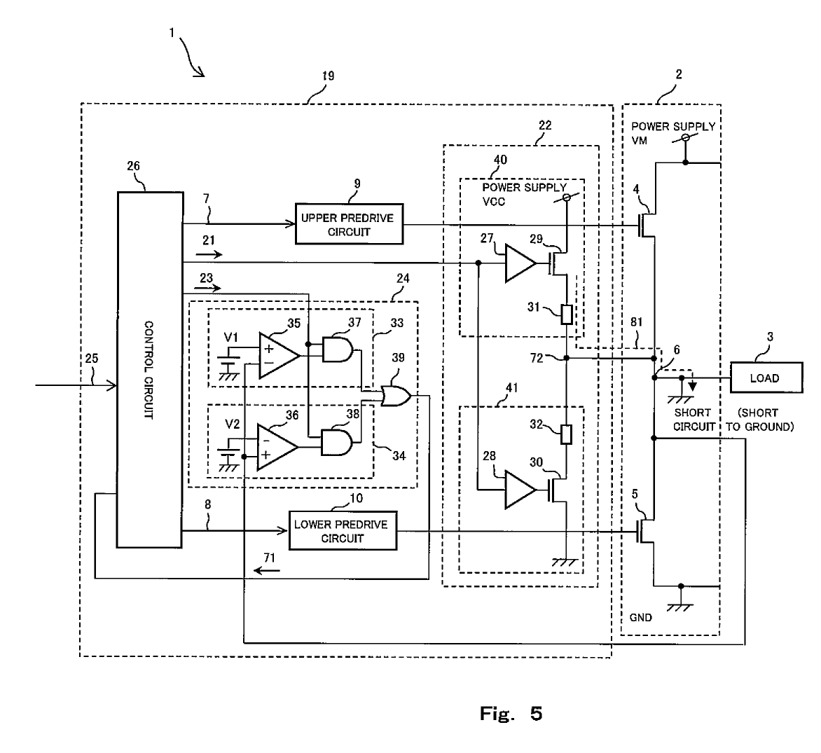

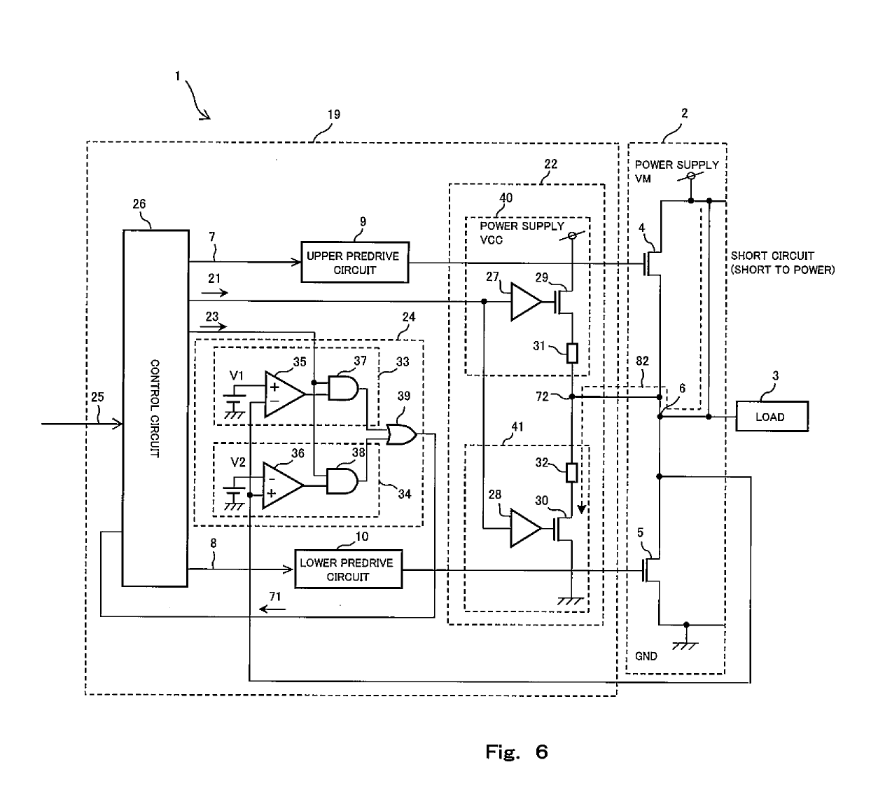

Next, the operational advantage of the output buffer circuit 1 which is configured as above and operates as above will be explained in reference to FIGS. 5 and 6.

FIG. 5 is a circuit diagram showing a condition of the output buffer circuit 1 in a case where the short to ground of the output portion 6 is occurring. FIG. 6 is a circuit diagram showing a condition of the output buffer circuit 1 in a case where the short to power of the output portion 6 is occurring.

Referring to FIG. 5, in a case where the short to ground of the output portion 6 is occurring, when the second output circuit 22 is turned on, the voltage VOUT of the output portion 6 becomes the GND. Then, a short-to-ground current 81 flows from the power supply VCC through the upper switching element 29, the upper resistor 31, the output terminal 72, the output portion 6, and a short-to-ground point to the GND. Therefore, the short-to-ground current 81 does not flow through the switching elements 4 and 5 constituting the first output circuit 2, so that the switching elements 4 and 5 are protected from the short to ground. Moreover, the current discharging ability of the second output circuit 22 is set to be lower than the current discharging ability of the upper switching element 4 of the first output circuit 2. Therefore, the short-to-ground current 81 is suppressed to be lower than the short-to-ground current flowing in a case where the first output circuit 2 is activated with the short to ground occurring. Specifically, the short-to-ground current 81 is suppressed by the ON resistance of the upper switching element 29 and the upper resistor 31, so that the short-to-ground current 81 does not become such a high current that the first output circuit 2 and the second output circuit 22 are destroyed.

Moreover, referring to FIG. 6, in a case where the short to power of the output portion 6 is occurring, when the second output circuit 22 is turned on, the voltage VOUT of the output portion 6 becomes VM. Then, a short-to-power current 82 flows from the power supply VM through a short-to-power point, the output portion 6, the output terminal 72, the lower resistor 32, and the lower switching element 30 to the GND. Therefore, the short-to-power current 82 does not flow through the switching elements 4 and 5 constituting the first output circuit 2, so that the switching elements 4 and 5 are protected from the short to power. Moreover, the current suctioning ability of the second output circuit 22 is set to be lower than the current suctioning ability of the lower switching element 5 of the first output circuit 2. Therefore, the short-to-power current 82 is suppressed to be lower than the short-to-power current flowing in a case where the first output circuit 2 is activated with the short to power occurring. Specifically, the short-to-power current 82 is suppressed by the ON resistance of the lower switching element 30 and the lower resistor 32 and does not become such a high current that the first output circuit 2 and the second output circuit 22 are destroyed.

Therefore, in accordance with the output buffer circuit 1 of the present embodiment, the switching elements 4 and 5 of the first output circuit 2 can be surely prevented from being destroyed by the short circuit.

Moreover, in accordance with the configuration of the output buffer circuit 1 of the present embodiment, since the upper output circuit and the lower output circuit are activated at the same time, the short circuit can be detected comparatively quickly.

### Embodiment 2

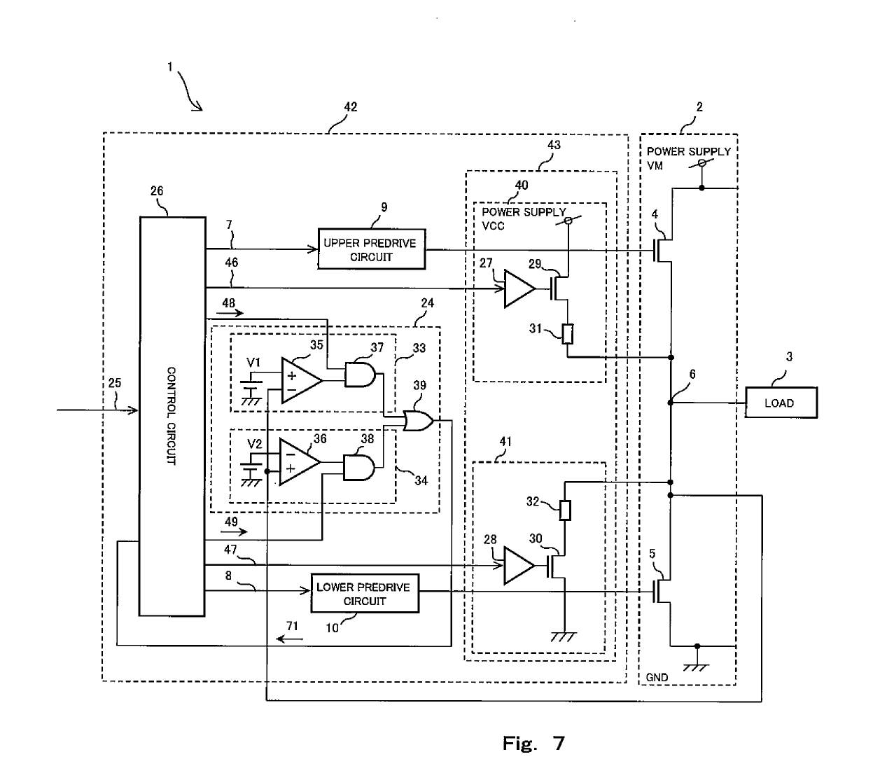

FIG. 7 is a circuit diagram showing the configuration of the output buffer circuit according to Embodiment 2 of the present invention.

As shown in FIG. 7, in the output buffer circuit 1 of the present embodiment, the upper output circuit 40 and the lower output circuit 41 are separately controlled by the control circuit 26, and the short-to-ground detecting circuit 33 and the short-to-power detecting circuit 34 are separately controlled by the control circuit 26. Other than these, the output buffer circuit 1 of the present embodiment is the same as the output buffer circuit 1 of Embodiment 1.

More specifically, an output control circuit 42 of the output buffer circuit 1 of the present embodiment includes a second output circuit 43 instead of the second output circuit 22 of the output control circuit 19 of Embodiment 1. The second output circuit 43 includes the upper output circuit 40 and the lower output circuit 41, which are configured to be the same as those of Embodiment 1. However, the control circuit 26 inputs an upper output circuit control signal 46 to the upper output circuit 40 and inputs a lower output circuit control signal 47 to the lower output circuit 41. With this, the upper output circuit 40 and the lower output circuit 41 are separately controlled by the control circuit 26. Moreover, the upper resistor 31 of the upper output circuit 40 and the lower resistor 32 of the lower output circuit 41 are not connected through the node 72 to the output portion 6 of the first output circuit 2 as in Embodiment 1 but individually connected to the output portion 6. However, the upper resistor 31 of the upper output circuit 40 and the lower resistor 32 of the lower output circuit 41 may be connected in the same manner as in Embodiment 1. In the present embodiment, each of a terminal of the upper resistor 31 of the upper output circuit 40 which terminal is connected to the output portion 6 and a terminal of the lower resistor 32 of the lower output circuit 41 which terminal is connected to the output portion 6 constitutes an output terminal of the second output circuit 43.

Moreover, the control circuit 26 inputs the short-to-ground detecting circuit control signal 48 and the short-to-power detecting circuit control signal 49 respectively to the short-to-ground detecting circuit 33 and the short-to-power detecting circuit 34 constituting the short-circuit detecting circuit 24. With this, the short-to-ground detecting circuit 33 and the short-to-power detecting circuit 34 are separately controlled by the control circuit 26.

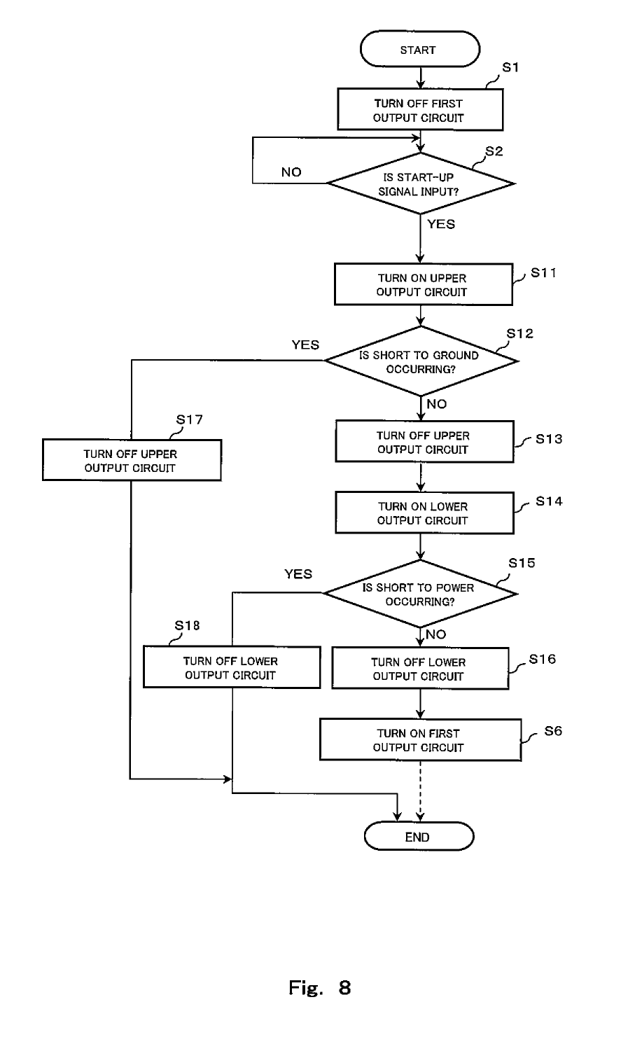

Next, the operation of the output buffer circuit 1 of the present embodiment configured as above will be explained in reference to FIG. 8.

FIG. 8 is a flow chart showing steps of the operation control by the control circuit 26 of the output buffer circuit 1 of FIG. 7.

The control circuit 26 turns off the first output circuit 2 (Step S1) and stands by for the input of the start-up signal (Step S2).

When the start-up signal is input to the control circuit 26 (YES in Step S2), the control circuit 26 causes the upper output circuit control signal 46 to be H. Then, the upper switching element 29 of the upper output circuit 40 is turned on. With this, the upper output circuit 40 is turned on (Step S11).

Next, the control circuit 26 determines whether or not the short to ground is occurring (Step S12). Specifically, the control circuit 26 causes the short-to-ground detecting circuit control signal 48 to be H. With this, the inhibit circuit constituted by the short-to-ground detecting AND circuit 37 is canceled. Thus, the short to ground can be detected.

Here, as described above, in a case where the short to ground of the output portion 6 is occurring, the voltage VOUT of the output portion 6 becomes the GND and falls below the reference voltage V1. Therefore, the short-to-ground detection comparator 35 outputs H, and the short-to-ground detecting AND circuit 37 outputs H. With this, the output 71 of the short-circuit detecting OR circuit 39 becomes H, and the control circuit 26 determines that the short to ground (short circuit) of the output portion 6 is occurring (YES in Step S12).

When the control circuit 26 determines that the short to ground is occurring, the control circuit 26 causes the upper output circuit control signal 46 to be L. Then, the upper switching element 29 of the upper output circuit 40 is turned off. With this, the upper output circuit 40 is turned off (Step S17).

Then, the control circuit 26 terminates start-up control of the output buffer circuit 1.

Meanwhile, as described above, in a case where the short to ground of the output portion 6 is not occurring, the voltage VOUT of the output portion 6 becomes VZ or VCC and exceeds the reference voltage V1. Therefore, the short-to-ground detection comparator 35 outputs L, and the short-to-ground detecting AND circuit 37 outputs L. With this, the output 71 of the short-circuit detecting OR circuit 39 becomes L, and the control circuit 26 determines that the short to ground (short circuit) of the output portion 6 is not occurring (NO in Step S12).

When the control circuit 26 determines that the short to ground is not occurring, the control circuit 26 causes the upper output circuit control signal 46 to be L to turn off the upper output circuit 40 (Step S13).

Next, the control circuit 26 causes the lower output circuit control signal 47 to be H. Then, the lower switching element 30 of the lower output circuit 41 is turned on. With this, the lower output circuit 41 is turned on (Step S14).

Next, the control circuit 26 determines whether or not the short to power is occurring (Step S15). Specifically, the control circuit 26 causes the short-to-power detecting circuit control signal 49 to be H. With this, the inhibit circuit constituted by the short-to-power detecting AND circuit 38 is canceled. Thus, the short to power can be detected.

Here, as described above, in a case where the short to power of the output portion 6 is occurring, the voltage VOUT of the output portion 6 becomes VM and exceeds the reference voltage V2. Therefore, the short-to-power detection comparator 36 outputs H, and the short-to-power detecting AND circuit 38 outputs H. With this, the output 71 of the short-circuit detecting OR circuit 39 becomes H, and the control circuit 26 determines that the short to power (short circuit) of the output portion 6 is occurring (YES in Step S15).

When the control circuit 26 determines that the short to power is occurring, the control circuit 26 causes the lower output circuit control signal 47 to be L. Then, the lower switching element 30 of the lower output circuit 41 is turned off. With this, the lower output circuit 41 is turned off (Step S18).

Then, the control circuit 26 terminates the start-up control of the output buffer circuit 1.

Meanwhile, as described above, in a case where the short to power of the output portion 6 is not occurring, the voltage VOUT of the output portion 6 becomes VZ and falls below the reference voltage V2. Therefore, the short-to-power detection comparator 36 outputs L, and the short-to-power detecting AND circuit 38 outputs L. With this, the output 71 of the short-circuit detecting OR circuit 39 becomes L, and the control circuit 26 determines that the short to power (short circuit) of the output portion 6 is not occurring (NO in Step S15).

When the control circuit 26 determines that the short to power is not occurring, the control circuit 26 causes the lower output circuit control signal 47 to be L to turn off the lower output circuit 41 (Step S16).

Then, the control circuit 26 turns on the first output circuit 2 (Step S6). Then, when the stop signal is finally input to the control circuit 26, the control circuit 26 turns off the first output circuit 2 to terminate the control of the output buffer circuit 1.

In Embodiment 2, the reference voltages V1 and V2 needs to be set in consideration of the following. To be specific, the short circuit of the output portion 6 may occur through a resistor. In this case, the voltage of the output portion 6 becomes an intermediate value between VM and VZ or between GND and VZ. Therefore, in order to surely detect the short circuit in this case, it is desirable that the reference voltage V1 be set to be as close to VCC as possible and the reference voltage V2 be set to be as close to GND as possible. However, if the reference voltage V1 is too close to VCC and the reference voltage V2 is too close to GND, the possibility of occurrence of malfunctions (non-detections of the short circuit) increases. Therefore, each of the reference voltages V1 and V2 needs to be set in consideration of every changing factor to a level that the malfunctions do not occur.

In accordance with the output buffer circuit 1 of the present embodiment explained as above, the short-to-ground current and the short-to-power current do not flow through the switching elements 4 and 5 constituting the first output circuit 2. Therefore, the switching elements 4 and 5 are protected from the short to ground and the short to power. The short-to-ground current is suppressed by the ON resistance of the upper switching element 29 and the upper resistor 31, and the short-to-power current is suppressed by the ON resistance of the lower switching element 30 and the lower resistor 32. Therefore, each of these currents does not become such a high current that the first output circuit 2 and the second output circuit 22 are destroyed.

Therefore, as with Embodiment 1, the output buffer circuit 1 of the present embodiment can surely prevent the switching elements 4 and 5 of the first output circuit 2 from being destroyed by the short circuit. In addition, the current of the second output circuit 43 is suppressed as compared to a case where the upper output circuit 40 and the lower output circuit 41 are activated at the same time as in Embodiment 1. Therefore, the short circuit can be detected with low power consumption.

In the foregoing, the short-to-ground detection in which the upper output circuit 40 is turned on is carried out before the short-to-power detection in which the lower output circuit 41 is turned on. However, these detections may be carried out in reverse order.

### Embodiment 3

Embodiment 3 of the present invention is a variation of Embodiment 2. The configuration of the output buffer circuit 1 of the present embodiment is completely the same as the configuration of the output buffer circuit 1 of FIG. 7. However, when detecting the short circuit, the upper output circuit 40 and the lower output circuit 41 are similarly turned on and off as with Embodiment 1. Moreover, when the short circuit is not detected, the second output circuit 43 is activated at the same timing as the first output circuit 2 in a complementary manner.

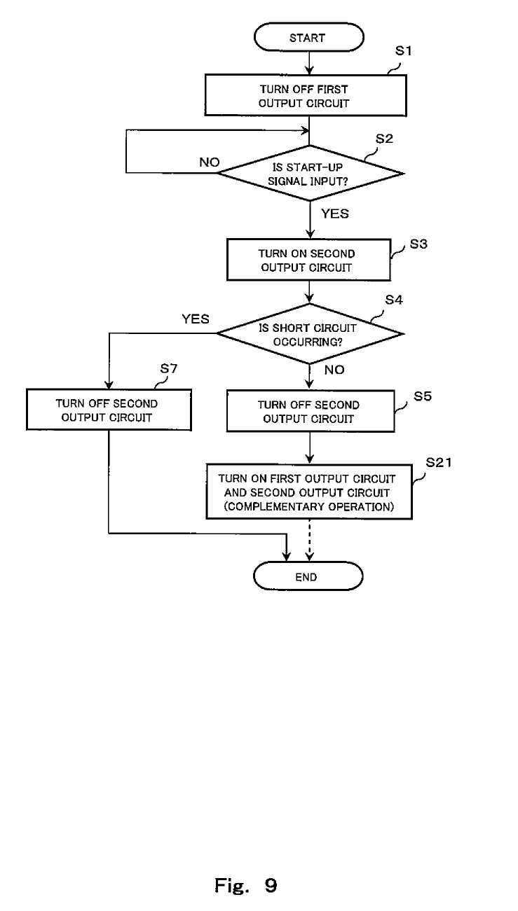

Hereinafter, the operation of the output buffer circuit 1 of the present embodiment will be explained in reference to FIG. 9.

FIG. 9 is a flow chart showing steps of the operation control by the control circuit 26 of the output buffer circuit 1 of the present embodiment.

As shown in FIG. 9, Steps S1 to S5 and S7 are the same as those in the flow chart of FIG. 3 of Embodiment 1. Therefore, the output buffer circuit 1 of the present embodiment operates in the same manner as the output buffer circuit 1 of Embodiment 1 from the start-up up to the short circuit detection. However, in Step S2, the control circuit 26 causes both the upper output circuit control signal 46 and the lower output circuit control signal 47 to be H to turn on the upper output circuit 40 and the lower output circuit 41 at the same time, thereby turning on the second output circuit 43. Moreover, in Step S4, the control circuit 26 causes both the short-to-ground detecting circuit control signal 48 and the short-to-power detecting circuit control signal 49 to be H. With this, the inhibit circuits respectively constituted by the short-to-ground detecting AND circuit 37 and the short-to-power detecting AND circuit 38 are canceled. Thus, the short to ground and the short to power can be detected. Moreover, in Steps S5 and S7, the control circuit 26 causes both the upper output circuit control signal 46 and the lower output circuit control signal 47 to be L to turn off the upper output circuit 40 and the lower output circuit 41 at the same time, thereby turning off the second output circuit 43.

Then, in Step S21, the control circuit 26 turns on the first output circuit 2 to cause the upper switching element 4 and the lower switching element 5 to operate in a complementary manner. Moreover, the control circuit 26 turns on the second output circuit 43 to cause the upper switching element 29 and the lower switching element 30 to operate at the same timing as the upper switching element 4 and the lower switching element 5 of the first output circuit 2 in a complementary manner.

Specifically, in a case where the output command signal is a signal indicating that H needs to be output, the control circuit 26 causes the upper switching element control signal 7 to be H and causes the lower switching element control signal 8 to be L. Moreover, the control circuit 26 causes the upper output circuit control signal 46 to be H and causes the lower output circuit control signal 47 to be L. With this, in the first output circuit 2, the upper switching element 4 is turned on and the lower switching element 5 is turned off. Moreover, in the second output circuit 43, the upper switching element 29 is turned on and the lower switching element 5 is turned off. With this, the output portion 6 outputs the signal of H (voltage value VM) to the load 3.

In contrast, in a case where the output command signal is a signal indicating that L needs to be output, the control circuit 26 causes the upper switching element control signal 7 to be L and causes the lower switching element control signal 8 to be H. Moreover, the control circuit 26 causes the upper output circuit control signal 46 to be L and causes the lower output circuit control signal 47 to be H. With this, in the first output circuit 2, the upper switching element 4 is turned off and the lower switching element 5 is turned on. Moreover, in the second output circuit 43, the upper switching element 29 is turned off and the lower switching element 5 is turned on. With this, the output portion 6 outputs the signal of L (voltage value GND) to the load 3.

Then, when the stop signal is finally input to the control circuit 26, the control circuit 26 turns off the first output circuit 2 and the second output circuit 43 to terminate the control of the output buffer circuit 1.

In accordance with the output buffer circuit 1 of the present embodiment described as above, the load 3 can be driven by the current ability which is higher by the second output circuit 43 than a case where only the first output circuit 2 is activated.

### Embodiment 4

Embodiment 4 of the present invention is an embodiment in which the output buffer circuit 1 of Embodiment 1 is applied to a three-phase load.

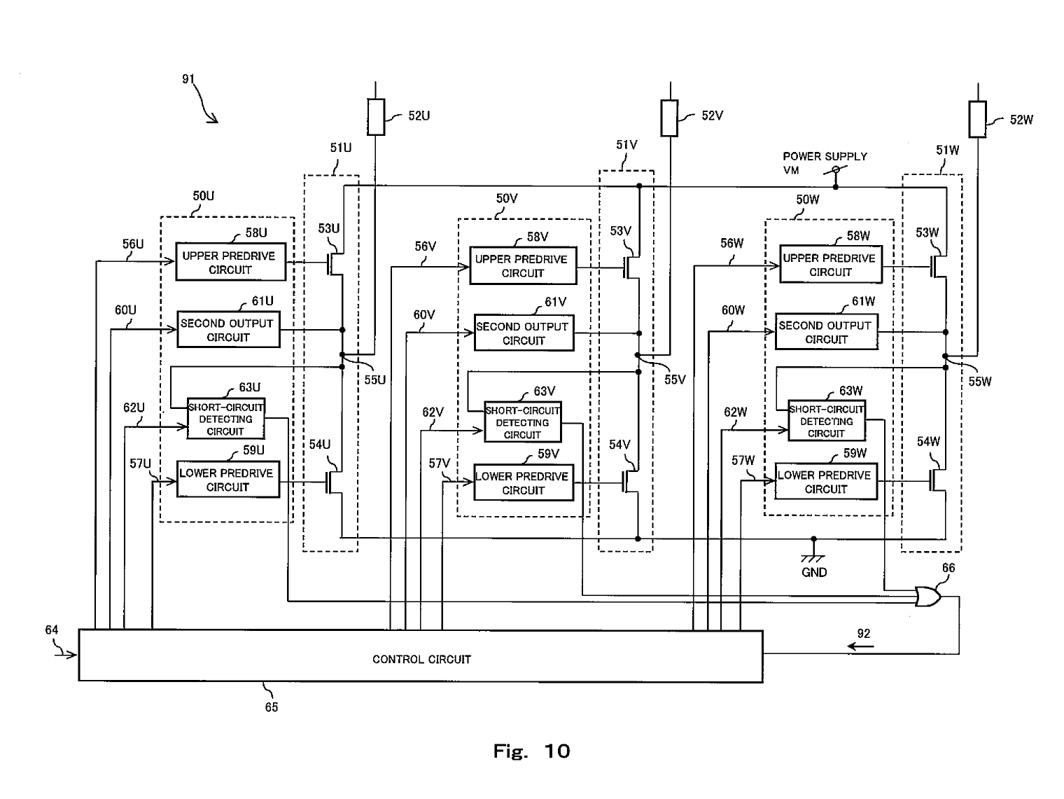

FIG. 10 is a circuit diagram showing the configuration of a three-phase output buffer system according to Embodiment 4 of the present invention.

A three-phase output buffer system (output buffer system) 91 of the present embodiment includes a first output circuit 51U and an output control circuit 50U corresponding to a U phase, a first output circuit 51V and an output control circuit 50V corresponding to a V phase, and a first output circuit 51W and an output control circuit 50W corresponding to a W phase. Then, the three-phase output buffer system 91 includes a control circuit 65 which is shared by the U phase, the V phase, and the W phase. Moreover, an output portion 55U of the first output circuit 51U corresponding to the U phase (hereinafter referred to as “of the U phase”) is connected to a U-phase load 52U, an output portion 55V of the first output circuit 51V corresponding to the V phase (hereinafter referred to as “of the V phase”) is connected to a V-phase load 52V, and an output portion 55W of the first output circuit 51W corresponding to the W phase (hereinafter referred to as “of the W phase”) is connected to a W-phase load 52W. Moreover, output signals of short-circuit detecting circuits 63U, 63V, and 63W are input to an OR circuit 66, and an output of the OR circuit 66 is input to the control circuit 65 as a short-circuit detection signal 92. Each of the first output circuits 51U, 51V, and 51W corresponds to the first output circuit 2 of the output buffer circuit 1 of Embodiment 1. Each of the output control circuits 50U 50V, and 50W corresponds to a group of components, other than the control circuit 26, in the output control circuit 19 of the output buffer circuit 1 of Embodiment 1. Therefore, although different reference numbers from the components in the output buffer circuit 1 of Embodiment 1 are used, respective components constituting the first output circuits 51U, 51V, and 51W and respective components constituting the output control circuits 50U, 50V, and 50W are configured to be the same as corresponding components of the output buffer circuit 1 of Embodiment 1 and have the same functions as corresponding components of the output buffer circuit 1 of Embodiment 1. Therefore, a repetition of the same explanation is avoided. Each of the reference numbers 53U, 53V, and 53W denotes an upper switching element, and each of the reference numbers 54U, 54V, and 54W denotes a lower switching element. Each of the reference numbers 58U, 58V, and 58W denotes an upper predrive circuit, and each of the reference numbers 59U, 59V, and 59W denotes a lower predrive circuit. Each of the reference numbers 56U, 56V, and 56W denotes an upper switching element control signal, and each of the reference numbers 57U, 57V, and 57W denotes a lower switching element control signal.

The control regarding each of the U phase, the V phase, and the W phase by the control circuit 65 is the same as the control by the control circuit 26 of the output buffer circuit 1 of Embodiment 1. Therefore, explanations thereof are simplified below, and mutual control among the U phase, the V phase, and the W phase by the control circuit 65 will be mainly explained.

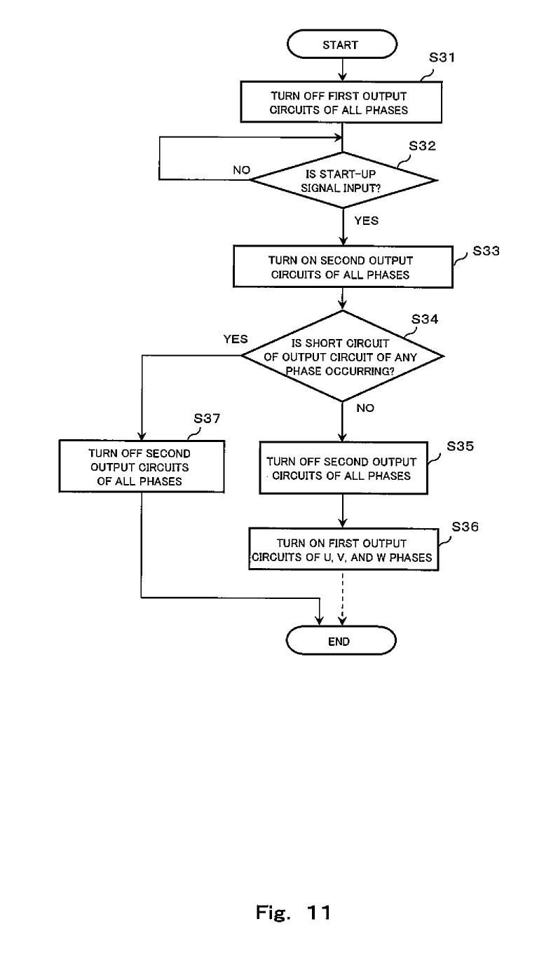

Next, the operation of the three-phase output buffer system 91 of the present embodiment will be explained in reference to FIG. 11.

FIG. 11 is a flow chart showing steps of the operation control by the control circuit 65 of the three-phase output buffer system 91 of the present embodiment.

As shown in FIG. 11, when starting up the three-phase output buffer system 91, the control circuit 65 first turns off all the first output circuits 51U, 51V, and 51W (Step S31).

Next, the control circuit 65 stands by for the input of the start-up signal as a start-up/stop signal 64 (Step S32). This start-up signal is a command signal for starting up the first output circuit 51U, 51V, or 51W.

Then, when the start-up signal of the first output circuit 51U, 51V, or 51W is input (YES in Step S32), the control circuit 65 turns on all the second output circuits 61U, 61V, and 61W (Step S33).

Next, the control circuit 65 outputs short-circuit detecting circuit control signals 62U, 62V, and 62W of H respectively to short-circuit detecting circuits 63U, 63V, and 63W to detect the short circuits of the output portions 55U, 55V, and 55W (Step S34). The output signals of the short-circuit detecting circuits 63U, 63V, and 63W are input to the OR circuit 66. Therefore, in a case where the short circuit is occurring at the output portion 55U, 55V, or 55W, the short-circuit detection signal 92 of the OR circuit 66 becomes H, and the control circuit 65 determines that the short circuit is occurring in the output portion 55U, 55V, or 55W (YES in Step S34).

When the control circuit 65 determines that the short circuit is occurring, the control circuit 65 turns off all the second output circuits 61U, 61V, and 61W (Step S37) and then terminates the control of the three-phase output buffer system 91.

In contrast, in a case where the short circuit is not occurring at the output portions 55U, 55V, and 55W, the short-circuit detection signal 92 of the OR circuit 66 becomes L, and the control circuit 65 determines that the short circuit is not occurring at the output portions 55U, 55V, and 55W (NO in Step S34).

When the control circuit 65 determines that the short circuit is not occurring, the control circuit 65 turns off all the second output circuits 61U, 61V, and 61W (Step S35).

Then, the control circuit 65 turns on all the first output circuits 51U, 51V, and 51W (Step S36). Then, when the stop signal of each of the first output circuits 51U, 51V, and 51W is finally input as the start-up/stop signal 64, the control circuit 65 turns off all the first output circuits 51U, 51V, and 51W to terminate the control of the three-phase output buffer system 91.

In accordance with the three-phase output buffer system 91 of the present embodiment configured as above, the output buffer circuit of the present invention can be applied to a plurality of loads. In addition, in a case where the short circuit is occurring at the first output circuit 51U, 51V, or 51W, the entire system can be stopped quickly.

In the foregoing, the output buffer circuit 1 of Embodiment 1 is applied to the three-phase load, but may be applied to a multi-phase load other than the three-phase load. In addition, the plurality of loads are not limited to the multi-phase loads and may be a group of single-phase loads.

Moreover, in the foregoing, each of the output buffer circuits is constituted by the output buffer circuit 1 of Embodiment 1. However, each of the output buffer circuits may be constituted by the output buffer circuit of Embodiment 2 or 3.

Moreover, in the foregoing, the control circuit 65 is provided, which is shared by respective phases. However, the control circuits may be respectively provided for the output control circuits 50U, 50V, and 50W. Respective phases may be controlled by corresponding control circuits, and mutual control among respective phases may be carried out by one of these control circuits. Moreover, as with Embodiment 1, the control circuits may be respectively provided for the output control circuits 50U, 50V, and 50W, and a control circuit configured to carry out mutual control among respective phases may be additionally provided.

Moreover, in Embodiments 1 to 4, each of the second output circuits 22, 43, 61U, 61V, and 61W is constituted by a switching element (and a resistive element) connected to a voltage applying unit. However, the present invention is not limited to this. For example, each of the second output circuits 22, 43, 61U, 61V, and 61W may be constituted by a power supply configured to output a predetermined voltage.

Moreover, in Embodiments 1 to 4, the voltage of the output portion 6 is detected to detect the short circuit. However, the present invention is not limited to this. For example, the short-circuit current may be detected.

The output buffer circuit and output buffer system of the present invention are useful as an output buffer circuit and output buffer system, such as a power amplifier of an acoustic equipment, an audio output circuit of TV, and an output circuit of a motor drive circuit, configured to drive a comparatively high current load.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the spirit of the present invention.

What is claimed is:

1. An output buffer circuit comprising:
a first output circuit including a first high voltage side switching element and a first low voltage side switching element, the first high voltage side switching element having main terminals, one of the main terminals being maintained at a first voltage, the first low voltage side switching element having main terminals, one of the main terminals being connected to the other main terminal of the high voltage side switching element, the other main terminal of the first low voltage side switching element being maintained at a second voltage which is lower than the first voltage, a portion where the other main terminal of the first high voltage side switching element and said one of the main terminals of the first low voltage side switching element are connected to each other constituting an output portion for output to outside;
a second output circuit having an output terminal connected to the output portion of the first output circuit; and
a short-circuit detecting circuit configured to detect a short circuit between the output portion of the first output circuit and an electrical path which is maintained at the first voltage or between the output portion of the first output circuit and an electrical path which is maintained at the second voltage (such short circuit is hereinafter referred to as “the short circuit of the output portion”), wherein:
when starting up the output buffer circuit, the second output circuit and the short-circuit detecting circuit are activated before activating the first output circuit; when the short circuit of the output portion is not detected, the first output circuit is activated; and when the short circuit of the output portion is detected, the first output circuit is not activated.

2. The output buffer circuit according to claim 1, further comprising a control circuit configured to control operations of the first output circuit, the second output circuit, and the short-circuit detecting circuit, wherein
the control circuit is configured such that: when starting up the output buffer circuit, the control circuit activates the second output circuit and the short-circuit detecting circuit before activating the first output circuit; when the short circuit of the output portion is not detected, the control circuit activates the first output circuit; and when the short circuit of the output portion is detected, the control circuit does not activate the first output circuit.

3. The output buffer circuit according to claim 1, wherein a current drive ability of the second output circuit is lower than a current drive ability performed by the first high voltage side switching element of the first output circuit and the first low voltage side switching element of the first output circuit.

4. The output buffer circuit according to claim 1, wherein the second output circuit includes a high voltage side output circuit configured to discharge a current to the output terminal and a low voltage side output circuit configured to suction the current from the output terminal.

5. The output buffer circuit according to claim 4, wherein the high voltage side output circuit and the low voltage side output circuit are activated at the same time, and the short-circuit detecting circuit is activated.

6. The output buffer circuit according to claim 4, wherein the output buffer circuit is configured such that:
one of the high voltage side output circuit and the low voltage side output circuit is activated, and the short-circuit detecting circuit is activated; and
when the short circuit is not detected, the other one of the high voltage side output circuit and the low voltage side output circuit is activated, and the short-circuit detecting circuit is activated.

7. The output buffer circuit according to claim 1, wherein the short-circuit detecting circuit is configured to compare a voltage of the output portion of the first output circuit with a preset voltage to detect the short circuit.

8. The output buffer circuit according to claim 4, wherein the output buffer circuit is configured such that when activating the first output circuit, the first high voltage side switching element of the first output circuit and the high voltage side output circuit of the second output circuit are turned on at the same time and the first low voltage side switching element of the first output circuit and the low voltage side output circuit of the second output circuit are turned off at the same time, or the first high voltage side switching element of the first output circuit and the high voltage side output circuit of the second output circuit are turned off at the same time and the first low voltage side switching element of the first output circuit and the low voltage side output circuit of the second output circuit are turned on at the same time.

9. The output buffer circuit according to claim 1, wherein the second output circuit includes a second high voltage side switching element and a second low voltage side switching element, the second high voltage side switching element having main terminals, one of the main terminals being maintained at a third voltage, the second low voltage side switching element having main terminals, one of the main terminals being connected to the other main terminal of the second high voltage side switching element, the other one of the main terminals of the second low voltage side switching element being maintained at a fourth voltage which is lower than the third voltage, a portion where the other main terminal of the second high voltage side switching element and said one of the main terminals of the second low voltage side switching element are connected to each other constituting the output terminal of the second output circuit.

10. The output buffer circuit according to claim 9, wherein the second high voltage side switching element constitutes a high voltage side output circuit configured to discharge a current to the output terminal, and the second low voltage side switching element constitutes a low voltage side output circuit configured to suction the current from the output terminal.

11. The output buffer circuit according to claim 1, wherein when the short-circuit detecting circuit does not detect the short circuit of the output portion, the second output circuit stops operating.

12. An output buffer system comprising a plurality of the output buffer circuits according to claim 1, wherein
when the short circuit of the output portion of the first output circuit of any one of the output buffer circuits is detected, the first output circuits of all the output buffer circuits are not activated.
